(19) United States
(12) Patent Application Publication
(10) Pub. No.: US 2026/0197651 A1
(43) Pub. Date: Jul. 9, 2026

(54) CONNECTED DEVICE DISCOVERY AUTHORIZATION SYSTEM FOR VEHICLE

(71) Applicant: FCA US LLC, Auburn Hills, MI (US)

(72) Inventors: Christopher R. Piechocki, Auburn Hills, MI (US); Daniel P. Cashen, Auburn Hills, MI (US); Chung H. Baik, Auburn Hills, MI (US); Rajeev K. Tiwari, Auburn Hills, MI (US)

(21) Appl. No.: 19/014,311

(22) Filed: Jan. 9, 2025

(51) Int. Cl. H04W 12/088; H04L 67/12

(52) U.S. Cl. CPC H04W 12/088; H04L 67/12

(57) ABSTRACT

A vehicle communication network with a service oriented architecture (SOA) includes a primary computing device designated for device authorization operations, a zone computing device in signal communication with the primary computing device via the communication network, and a plurality of edge devices in signal communication with the zone computing device and/or the primary computing device via the communication network. The primary computing device is configured to perform device authorization operations, including, receive broadcasted IDs from each of the edge devices, build/update a manifest of the plurality of edge devices based on the broadcasted IDs, reference the manifest and a list of authorized devices that are authorized to operate on the vehicle communication network, to thereby identify one or more unauthorized devices on the vehicle communication network, and prevent operation of the one or more unauthorized devices.

### FIELD

The present application relates generally to vehicle electrical architectures and, more particularly, service oriented architectures for a vehicle.

### BACKGROUND

Current vehicle electrical architectures often include a plurality of different electronic control units (ECUs) configured to control various components or functions of the vehicle. The ECUs typically require knowledge of the sensors, actuators, and other ECUs installed in the vehicle to carry out their functions. This information is traditionally conveyed through fixed communication networks (i.e., designated senders and receivers of network data) and by writing diagnostic details of the vehicle's setup to the non-volatile memory (NVM) of one or more ECUs. These details outline the components present in the vehicle. Once the configurations are written to at least one of the vehicle's ECUs, they are then shared with the other ECUs in the system. Subsequently, data transmission occurs exclusively among the ECUs specified in a predefined network configuration. One advancement in vehicle electrical architectures utilizes service oriented architectures (SOAs), which eliminate this need for predetermined senders and receivers of data. However, the SOAs often lack controls for unauthorized devices. Accordingly, while such conventional systems do work well for their intended purpose, it is desirable to provide continuous improvement in the relevant art.

### SUMMARY

In accordance with one example aspect of the invention, a vehicle communication network with a service oriented architecture (SOA) is provided. In one example implementation, the communication network includes a primary computing device designated for device authorization operations, a zone computing device in signal communication with the primary computing device via the communication network, and a plurality of edge devices in signal communication with the zone computing device and/or the primary computing device via the communication network. The primary computing device is configured to perform device authorization operations, including, receive broadcasted IDs from each of the edge devices, build/update a manifest of the plurality of edge devices based on the broadcasted IDs, reference the manifest and a list of authorized devices that are authorized to operate on the vehicle communication network, to thereby identify one or more unauthorized devices on the vehicle communication network, and prevent operation of the one or more unauthorized devices.

In addition to the foregoing, the described vehicle communication network may include one or more of the following features: wherein each of the edge devices is configured to broadcast their device ID via the SOA, discover available services within the communication network via the SOA, and subscribe to the available services via the SOA; wherein preventing operation of the one or more unauthorized devices includes commanding, by the primary computing device, the one or more unauthorized devices to cease functioning; and wherein preventing operation of the one or more unauthorized devices includes restricting, by the primary computing device, publishing of services to the one or more unauthorized devices to thereby prevent operation of the one or more unauthorized devices.

In addition to the foregoing, the described vehicle communication network may include one or more of the following features: wherein preventing operation of the one or more unauthorized devices includes restricting, by the primary computing device, broadcasting of available services to the one or more unauthorized devices to thereby prevent operation of the one or more unauthorized devices; wherein preventing operation of the one or more unauthorized devices includes blocking, by the primary computing device and a network firewall, network traffic to the one or more unauthorized devices to thereby prevent operation of the one or more unauthorized devices; wherein the list of authorized devices is loaded into a memory of the primary computing device; wherein the list of authorized devices is provided by a backend server; and wherein the list of authorized devices is provided during assembly of the vehicle communication network.

In accordance with another example aspect of the invention, a device authorization method is provided for a vehicle communication network having a service oriented architecture (SOA), a primary computing device designated to perform device authorization operations, a zone computing device, and a plurality of edge devices. In one example implementation, the method includes receiving, at the primary computing device, broadcasted IDs from each of the edge devices; building and/or updating, at the primary computing device, a manifest of the plurality of edge devices based on the broadcasted IDs; referencing, by the primary computing device, the manifest and a list of authorized devices that are authorized to operate on the vehicle communication network, to thereby identify one or more unauthorized devices on the vehicle communication network; and preventing, by the primary computing device, operation of the one or more unauthorized devices.

In addition to the foregoing, the described method may include one or more of the following features: wherein each of the edge devices is configured to broadcast their device ID via the SOA, discover available services within the communication network via the SOA, and subscribe to the available services via the SOA; wherein preventing operation of the one or more unauthorized devices includes commanding, by the primary computing device, the one or more unauthorized devices to cease functioning; and wherein preventing operation of the one or more unauthorized devices includes restricting, by the primary computing device, publishing of services to the one or more unauthorized devices to thereby prevent operation of the one or more unauthorized devices.

In addition to the foregoing, the described method may include one or more of the following features: wherein preventing operation of the one or more unauthorized devices includes restricting, by the primary computing device, broadcasting of available services to the one or more unauthorized devices to thereby prevent operation of the one or more unauthorized devices; wherein preventing operation of the one or more unauthorized devices includes blocking, by the primary computing device and a network firewall, network traffic to the one or more unauthorized devices to thereby prevent operation of the one or more unauthorized devices; loading the list of authorized devices into a memory of the primary computing device; sending, by the primary computing device, a request to a backend server for the list of authorized devices, and receiving, at the central computing device, the list of authorized devices from the backend server; and wherein the list of authorized devices is provided during assembly of the vehicle communication network.

Further areas of applicability of the teachings of the present disclosure will become apparent from the detailed description, claims and the drawings provided hereinafter, wherein like reference numerals refer to like features throughout the several views of the drawings. It should be understood that the detailed description, including disclosed embodiments and drawings references therein, are merely exemplary in nature intended for purposes of illustration only and are not intended to limit the scope of the present disclosure, its application or uses. Thus, variations that do not depart from the gist of the present disclosure are intended to be within the scope of the present disclosure.

### BRIEF DESCRIPTION OF THE DRAWINGS

FIG. 1 is a functional block diagram of an example vehicle and communication network thereof in accordance with the principles of the present application;

FIG. 2 is an example architecture of a service oriented architecture of the vehicle communication network shown in FIG. 1, in accordance with the principles of the present application; and

FIGS. 3A-3C illustrate an example dataflow diagram of an example operation of the service oriented architecture of the vehicle communication network of FIGS. 1 and 2, in accordance with the principles of the present application.

### DESCRIPTION

As previously discussed, current vehicle electrical architectures often include a plurality of different electronic control units (ECUs) configured to control various components or functions of the vehicle. The ECUs typically require knowledge of the sensors, actuators, and other ECUs installed in the vehicle to carry out their functions. This information is traditionally conveyed through fixed communication networks (i.e., designated senders and receivers of network data) and by writing diagnostic details of the vehicle's setup to the non-volatile memory (NVM) of one or more ECUs. Some newer vehicle electrical architectures utilize service oriented architectures (SOAs), which eliminate this need for predetermined senders and receivers of data. However, the SOAs often lack controls for unauthorized devices.

Accordingly, described herein are systems and methods for a vehicle SOA configured to identify unauthorized devices (e.g., ECUs) and prevent the restricted devices from operating on the vehicle electrical architecture. In general, the control system is configured to dynamically check the authorization state of ECUs installed in the SOA vehicle, and subsequently disable unauthorized ECUs (e.g., ECUs recalled for defect). The dynamic checking of the control system is a critical aspect of maintaining security where devices may join or leave the network or status may change over time.

With the SOA, the system dynamically acquires knowledge of the installed components and their corresponding data requirements. This approach eliminates the need for predetermined senders and receivers of data. Additionally, there is no requirement to manually configure parameters in advance to communicate with specific ECUs to inform the vehicle about the installed components. Instead, the devices integrated into the vehicle can autonomously announce their presence and subscribe to data shared by other ECUs to execute their designated functions effectively. As such, vehicles equipped with the enabled SOA advantageously reduce manufacturing time, allow for dynamic vehicle configurations with less engineering/administrative effort, and allow for post-sale upgrades to be installed in less time and with lower cost.

However, one potential risk with a SOA is that if a restricted device (e.g., ECU, sensor, actuator, etc.) is installed in a vehicle, it would automatically be discovered and subscribe to the necessary data. This device could then operate, even if its fitness to operate is unchecked. A “restricted device” may be labeled as such, for example, due to country regulations, a recall, being an aftermarket component, etc. As such, the very nature of SOAs may present a challenge in that any connected device could potentially run without authorization.

Accordingly, to prevent such unauthorized operation, the system described herein includes a central computing device (“primary device”) configured to perform authorization operations. It will be appreciated that the central computing device may be any suitable device (e.g., any ECU) capable of performing authorization operations and is not restricted to a particular computing device. As such, the central computing device may also be referred to as a “designated computing device” configured to perform authorization operations, but the device may also perform other “normal” operations. Initially, the SOA includes a discovery phase that is initiated using the network connections between devices. Each connected device will broadcast their presence via a device ID, discover available services within the network, and subscribe to available services. The primary device is configured to build a manifest of the installed devices and then determine the authorization state of each device.

In the example embodiment, the primary device will determine the device authorization state by referencing a manifest of each discovered device ID against an authorization state stored in the primary device memory. The authorization state for each device ID is populated into the primary device memory, for example, by one or more of the following mechanisms: (i) loaded into memory at the software build time of the device (e.g., via the vehicle's internal communication network or secure gateway), (ii) loaded by an external server during device manufacturing, (iii) loaded by an external server during vehicle assembly, (iv) loaded by loaded by an external server during runtime via a wireless connection, and (v) loaded by specific event-driven updates (e.g., a recall).

Once the primary device identifies any unauthorized devices during the discovery or post-discovery phase, the primary device then takes one or more of the following actions to disable any unauthorized devices: (i) inform the unauthorized device that it is not authorized to perform its function—the unauthorized device then self-disables its functionality, and the system may introduce a feedback mechanism to confirm if the unauthorized device was disabled or not, (ii) restrict publishing data to prevent the unauthorized device from operating, (iii) restrict broadcasting of available services to the unauthorized device, and (iv) block the unauthorized device's network traffic via a network firewall (e.g., a central gateway with firewall, dynamic access control lists (ACLs), deep packet inspection, secure communication protocol, etc.).

Additionally, the system may be configured for periodic polling to regularly query devices at specified intervals and maintain a security posture. Further, a runtime solution can be implemented to check the authorization status and disable devices that were previously authorized, particularly where a device has a known defect that necessitates a recall. Cloud connectively is a key addition that allows for continuous homologation monitoring and compliance, and is critical to enable SOA in a complex lineup of vehicles.

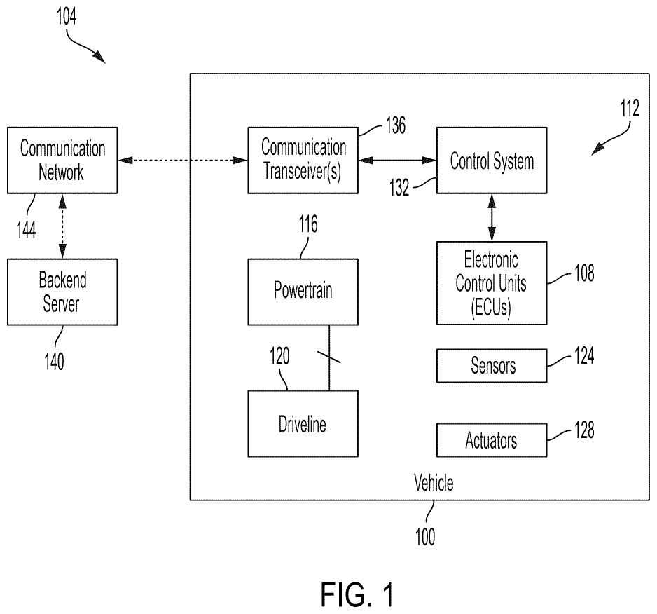

Referring now to FIG. 1, a functional block diagram of a vehicle 100 having a service oriented authorization (SOA) device authorization system 104 is illustrated according to the principles of the present application. The vehicle 100 includes a plurality of electronic control units (ECUs) 108-1 . . . 108-N (where N is an integer greater than one; collectively, “ECUs 108”) in communication with each other and with remote devices via a vehicle communication network 112. The vehicle 100 also generally includes a powertrain 116 configured to generate and transfer drive torque to a driveline 120 for vehicle propulsion.

The powertrain 116 could include any suitable components, such as, but not limited to, an internal combustion engine (ICE), one or more electric motors, one or more high voltage battery systems, and a transmission. The powertrain 116 could have any suitable torque generating configuration (ICE-only, ICE and electric motor(s), electric motor(s) only, etc.). The vehicle 100 also includes a set of sensor(s) 124, a set of actuator(s) 128, and a control system 132 for controlling operation of the vehicle 100. The control system 132 could be, for example, a supervisory ECU (also referred to as a primary device) of the ECUs 108, or the control system 132 could be a supervisory communication/network controller of the vehicle 100.

The vehicle 100 also includes one or more communication transceivers or telematics devices 136 each configured for communication via a particular wired or wireless communication protocol or a particular plurality of communication protocols. For example, two of the communication transceivers 136 could be configured for wired Ethernet and wireless Wi-Fi communication, respectively. It will be appreciated that the communication transceivers 136 could include interfaces for other (e.g., vehicle-specific) communication protocols.

As part of the techniques of the present application, an external computing system or backend server 140 is in communication with the control system 132 via a communication network 144 and the communication transceivers 136. In the example embodiment, the backend server 140 is configured to provide an up-to-date list of authorized and/or unauthorized devices (e.g., ECUs, sensors 124, actuators 128) present on the vehicle 100.

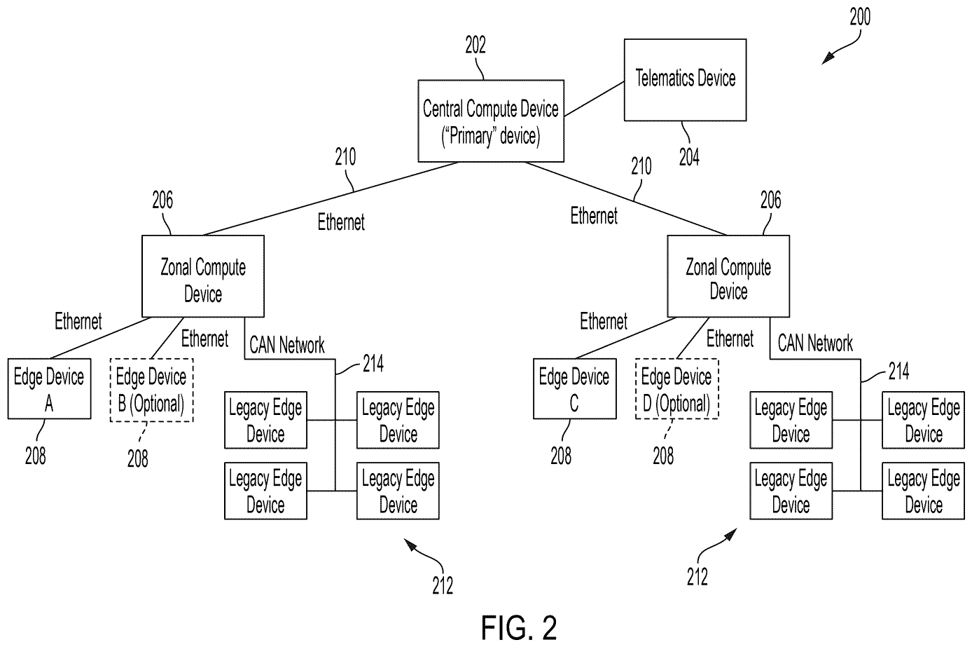

Referring now to FIG. 2, one example SOA electrical architecture 200 that includes the SOA device authorization system 104 is illustrated according to the principles of the present application. In the example embodiment, the SOA electrical architecture 200 generally includes a central computing device or primary device 202 (e.g., control system 132) in signal communication with a telematics device 204 (e.g., communication transceivers 136) and one or more zonal computing devices 206. The telematics device 204 is configured to communicate with the backend server 140, for example, via communication network 144.

In the example embodiment, the zonal computing devices are control systems responsible for localized control of sensors, actuators, etc. in a predefined zonal region of the vehicle, as well as supervising and gating communication within that zone. In general, the example architecture is hierarchical where some computing/control is performed in the zone for various reasons (e.g., latency, safety, reuse, etc.). The zonal computing devices 206 are is signal communication with one or more edge devices 208 (e.g., A-D, as shown). The edge devices 208 may be, for example only, ECUs, sensors, actuators, etc. The primary device 202, zonal devices 206, and edge devices 208 may communicate via any suitable network such as, for example, an ethernet network 210. The zonal computing devices 206 may also be in communication with one or more legacy edge devices 212 such as, for example, ECUs, sensors, actuators, etc. (e.g., a liftgate ECU). The zonal computing devices 206 may communicate via any suitable network such as, for example, a CAN network 214.

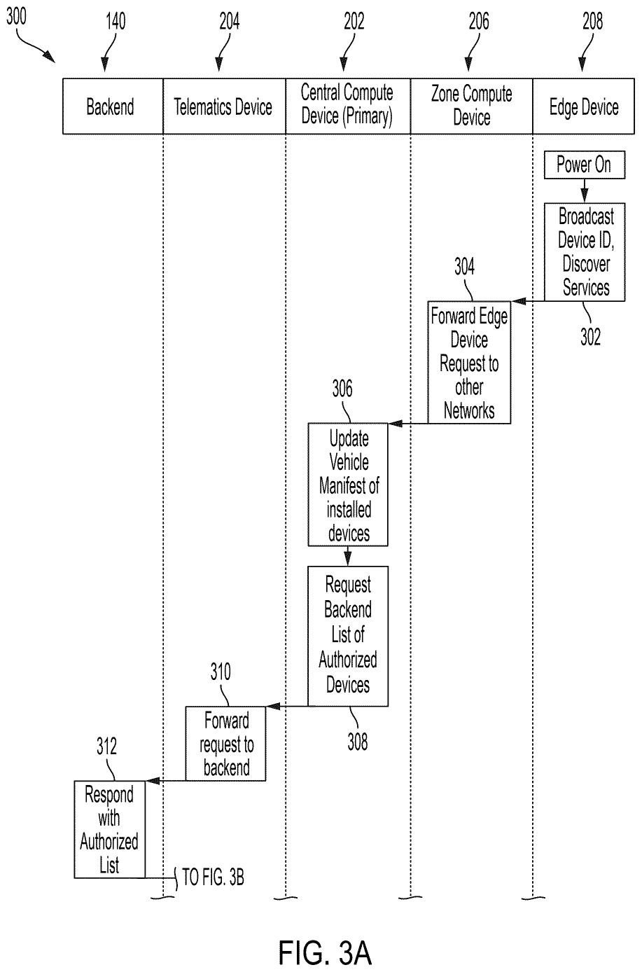

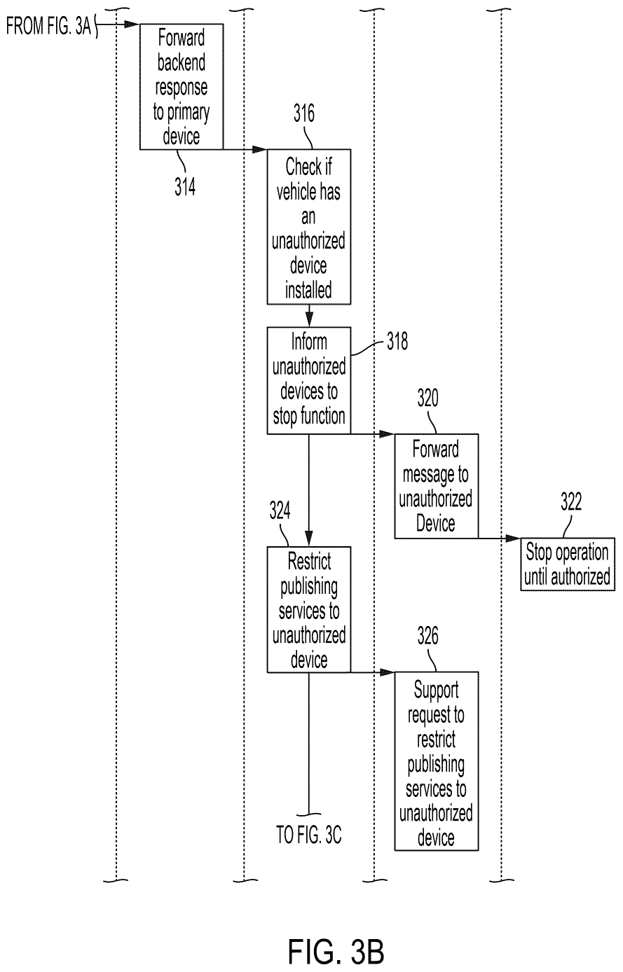

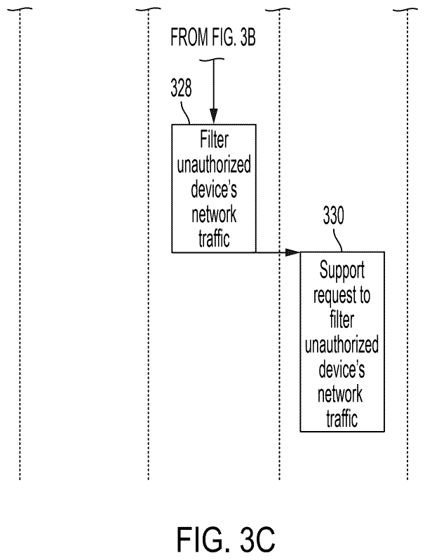

Referring now to FIGS. 3A-3C, an example dataflow diagram 300 illustrating a process for identifying and disabling unauthorized devices via the SOA 200 is illustrated according to the principles of the present application. While the components of FIGS. 1 and 2 are specifically referenced for illustrative/descriptive purposes, it will be appreciated that the method/process could be applicable to any suitable vehicle/network. In a first communication 302, with device power on, the edge devices 208 broadcast their device ID and discover available services within the network. This may also include sending a request to subscribe to available services. In a second communication 304, the zone computing device 206 forwards the edge device requests to other networks in the SOA 200.

In a third communication 306, the central computing device 202 builds or updates a manifest of the installed edge devices 208 (e.g., based on the received broadcasted device IDs). In a fourth communication 308, the central computing device 202 requests a list of authorized devices (e.g., from backend server 140). In a fifth communication 310, the telematics device 204 forwards the request from the central computing device 202 to the backend server 140. In a sixth communication 312, the backend server 140 receives the request and responds with an up-to-date list of authorized devices. In a seventh communication 314, the telematics device 204 forwards the response from the backend server 140 to the central computing device 202.

In an eighth communication 316, the central computing device 202 receives the list of authorized devices and cross-checks it with the manifest of installed devices to identify one or more unauthorized devices. Once an unauthorized device is identified, the central computing device 202 performs one or more of the following: (1) In a ninth communication 318, the central computing device 202 informs the unauthorized device to stop functioning. In a tenth communication 320, the zone computing device 206 forwards the message to the unauthorized device. In an eleventh communication 322, the unauthorized device 208 receives the message and ceases operation until authorized.

(2) Additionally, or alternatively, in a twelfth communication 324, the central computing device 202 restricts publishing services to the unauthorized device. In a thirteenth communication 326, the zone computing device 206 supports the request to restrict publishing services to the unauthorized device. For example, the zone computing device 206 may stop publishing its own services to the unauthorized device or filter/block any services from its regional network being sent to the unauthorized device.

(3) Additionally, or alternatively, in a fourteenth communication 328, the central computing device 202 filters the unauthorized device's network traffic. For example, the central computing device 202 may act as a gateway/router to enable the network communication (e.g., routing ethernet communication from one device to another). Any messages broadcasted from the unauthorized device can be blocked at the central computing device 202 so that other devices in the network do not receive the unauthorized messages.

In a fifteenth communication 330, the zone computing device 206 supports the request to filter the unauthorized device's network traffic. For example, the zone computing device 206 may block communication from the unauthorized device from being gated/routed within the zone/regional network of the vehicle. The process may then repeat periodically, be triggered by an event (e.g., a new device is installed on the SOA), etc.

It will be appreciated that the term “controller” or “module” or “computing server/device” as used herein refers to any suitable control device or set of multiple control devices that is/are configured to perform at least a portion of the techniques of the present disclosure. Non-limiting examples include an application-specific integrated circuit (ASIC), one or more processors and a non-transitory memory having instructions stored thereon that, when executed by the one or more processors, cause the controller to perform a set of operations corresponding to at least a portion of the techniques of the present disclosure. The one or more processors could be either a single processor or two or more processors operating in a parallel or distributed architecture.

It will be understood that the mixing and matching of features, elements, methodologies, systems and/or functions between various examples may be expressly contemplated herein so that one skilled in the art will appreciate from the present teachings that features, elements, systems and/or functions of one example may be incorporated into another example as appropriate, unless described otherwise above. It will also be understood that the description, including disclosed examples and drawings, is merely exemplary in nature intended for purposes of illustration only and is not intended to limit the scope of the present disclosure, its application or uses. Thus, variations that do not depart from the gist of the present disclosure are intended to be within the scope of the present disclosure.

What is claimed is:

1. A vehicle communication network with a service oriented architecture (SOA), the communication network comprising:
a primary computing device designated for device authorization operations;
a zone computing device in signal communication with the primary computing device via the communication network; and
a plurality of edge devices in signal communication with the zone computing device and/or the primary computing device via the communication network,
wherein the primary computing device is configured to perform device authorization operations comprising:
receive broadcasted IDs from each of the edge devices;
build/update a manifest of the plurality of edge devices based on the broadcasted IDs;
reference the manifest and a list of authorized devices that are authorized to operate on the vehicle communication network, to thereby identify one or more unauthorized devices on the vehicle communication network; and
prevent operation of the one or more unauthorized devices.

2. The vehicle communication network of claim 1, wherein each of the edge devices is configured to:
broadcast their device ID via the SOA;
discover available services within the communication network via the SOA; and
subscribe to the available services via the SOA.

3. The vehicle communication network of claim 1, wherein preventing operation of the one or more unauthorized devices comprises:
commanding, by the primary computing device, the one or more unauthorized devices to cease functioning.

4. The vehicle communication network of claim 1, wherein preventing operation of the one or more unauthorized devices comprises:
restricting, by the primary computing device, publishing of services to the one or more unauthorized devices to thereby prevent operation of the one or more unauthorized devices.

5. The vehicle communication network of claim 1, wherein preventing operation of the one or more unauthorized devices comprises:
restricting, by the primary computing device, broadcasting of available services to the one or more unauthorized devices to thereby prevent operation of the one or more unauthorized devices.

6. The vehicle communication network of claim 1, wherein preventing operation of the one or more unauthorized devices comprises:
blocking, by the primary computing device and a network firewall, network traffic to the one or more unauthorized devices to thereby prevent operation of the one or more unauthorized devices.

7. The vehicle communication network of claim 1, wherein the list of authorized devices is loaded into a memory of the primary computing device.

8. The vehicle communication network of claim 1, wherein the list of authorized devices is provided by a backend server.

9. The vehicle communication network of claim 1, wherein the list of authorized devices is provided during assembly of the vehicle communication network.

10. A device authorization method for a vehicle communication network having a service oriented architecture (SOA), a primary computing device designated to perform device authorization operations, a zone computing device, and a plurality of edge devices, the method comprising:
receiving, at the primary computing device, broadcasted IDs from each of the edge devices;
building and/or updating, at the primary computing device, a manifest of the plurality of edge devices based on the broadcasted IDs;
referencing, by the primary computing device, the manifest and a list of authorized devices that are authorized to operate on the vehicle communication network, to thereby identify one or more unauthorized devices on the vehicle communication network; and
preventing, by the primary computing device, operation of the one or more unauthorized devices.

11. The method of claim 10, wherein each of the edge devices is configured to:
broadcast their device ID via the SOA;
discover available services within the communication network via the SOA; and
subscribe to the available services via the SOA.

12. The method of claim 10, wherein preventing operation of the one or more unauthorized devices comprises:
commanding, by the primary computing device, the one or more unauthorized devices to cease functioning.

13. The method of claim 10, wherein preventing operation of the one or more unauthorized devices comprises:
restricting, by the primary computing device, publishing of services to the one or more unauthorized devices to thereby prevent operation of the one or more unauthorized devices.

14. The method of claim 10, wherein preventing operation of the one or more unauthorized devices comprises:
restricting, by the primary computing device, broadcasting of available services to the one or more unauthorized devices to thereby prevent operation of the one or more unauthorized devices.

15. The method of claim 10, wherein preventing operation of the one or more unauthorized devices comprises:
blocking, by the primary computing device and a network firewall, network traffic to the one or more unauthorized devices to thereby prevent operation of the one or more unauthorized devices.

16. The method of claim 10, further comprising loading the list of authorized devices into a memory of the primary computing device.

17. The method of claim 10, further comprising:
sending, by the primary computing device, a request to a backend server for the list of authorized devices; and
receiving, at the central computing device, the list of authorized devices from the backend server.

18. The method of claim 10, wherein the list of authorized devices is provided during assembly of the vehicle communication network.
